(19) United States
(12) Patent Application Publication
(10) Pub. No.: US 2013/0233349 A1
(43) Pub. Date: Sep. 12, 2013

(54) Systems and Methods to Clean Gas Turbine Fuel Chamber Components

(71) Applicant: Ron G. Lokey, Kiowa, OK (US)

(72) Inventor: Ron G. Lokey, Kiowa, OK (US)

(73) Assignee: GENERAL ELECTRIC COMPANY, Schenectady, NY (US)

(21) Appl. No.: 13/412,815

(22) Filed: Mar. 6, 2012

(51) Int. Cl. B08B 1/00; B08B 3/08

(52) U.S. Cl. 134/7; 134/157

(57) ABSTRACT

According to one embodiment, there is disclosed a method for cleaning deposits that have accumulated in a quaternary annulus chamber in a forward combustion can of a gas turbine. The method may include depositing a number of cleaning shot into the quaternary annulus chamber. The method may also include rotating the forward combustion can such that the cleaning shot tumbles within the quaternary annulus chamber.

### FIELD OF THE DISCLOSURE

Embodiments of the present application relate generally to the removal of deposit build-up, and more specifically to systems and methods to remove deposit build-up that may form inside fuel pathways in gas turbines.

### BACKGROUND OF THE DISCLOSURE

Certain gas turbines may include internal deposit build-up. For example, iron oxide corrosion products may form and cause an undesirable build-up of iron deposits inside fuel pathways or channels of the turbine combustion casings, or “cans.” Moreover, other types of undesirable build-up may occur due to impurities in a fuel. For example, FIGS. 1 and 2 schematically illustrate a gas turbine forward combustion can having a quaternary fuel circuit. A quaternary fuel gas inlet orifice leads to a quaternary fuel gas distribution annulus chamber extending around the circumference of the forward combustion can. The fuel gas in the quaternary annulus chamber is distributed by multiple quaternary pegs into the forward combustion chamber. Any iron oxide corrosion products that collect in the quaternary annulus chamber may result in blockage of the fuel gas passages in the quaternary pegs, which potentially interferes with the flame pattern in the combustion chamber. This blockage can lead to reduced efficiencies and increased nitrogen oxide emissions. When inspection of the forward casing indicates iron deposit build-up, cleaning of the quaternary annulus is recommended to insure reliable operation. As can be appreciated, the quaternary fuel gas distribution annulus chamber is a narrow passageway and is difficult to access and clean.

At present, the method of cleaning the quaternary fuel gas distribution annulus chamber involves cutting off the fuel pegs followed by attempts to hydro-blast the iron deposits by gaining access to the quaternary annulus channel via the fuel peg holes. This can only be done off-site at a facility equipped to cut and reattach the fuel pegs. In part due to the fuel peg removal and re-welding, the cleaning process is very time consuming and typically takes several weeks to process and restore the combustion chamber.

It would be desirable to provide a rapid system and method to clean critical fuel pathways in a gas turbine thus removing the potential for undesirable deposits to block fuel gas passages.

### BRIEF DESCRIPTION OF THE DISCLOSURE

Some or all of the above needs and/or problems may be addressed by certain embodiments of the present application. According to one embodiment, there is disclosed a method for cleaning deposits that have accumulated in a quaternary annulus chamber in a forward combustion can of a gas turbine. The method may include depositing a number of cleaning shot into the quaternary annulus chamber. The method may also include rotating the forward combustion can such that the cleaning shot tumbles within the quaternary annulus chamber.

According to another embodiment, there is disclosed a method for cleaning deposits that have accumulated in a quaternary annulus chamber in a forward combustion can of a gas turbine. The forward combustion can may include a quaternary fuel flange and a quaternary fuel inlet orifice leading to the quaternary annulus chamber. The forward combustion can may further include a number of quaternary fuel pegs in communication with the quaternary annulus chamber. The method may include removing the forward combustion can from the gas turbine and capping the quaternary fuel pegs. The method may also include depositing a first group of cleaning shot into the quaternary annulus chamber. The first group of cleaning shot may be deposited into the quaternary annulus chamber through the quaternary fuel inlet orifice of the quaternary fuel flange. The method may also include deposing a cleaning solution into the quaternary annulus chamber and rotating the forward combustion can a first cycle such that the first group of cleaning shot tumbles within the quaternary annulus chamber. The method may also include stopping the rotation of the forward combustion can after the first cycle and removing the first number of cleaning shot and the cleaning solution from the quaternary annulus chamber. The method may also include depositing a second group of cleaning shot into the quaternary annulus chamber. The second group of cleaning shot may be deposited into the quaternary annulus chamber through the quaternary fuel inlet orifice of the quaternary fuel flange. Moreover, the method may include rotating the forward combustion can a second cycle such that the second group of cleaning shot tumbles within the quaternary annulus chamber.

Further, according to another embodiment, there is disclosed a system for cleaning deposits that have accumulated in a quaternary annulus chamber in a forward combustion can of a gas turbine. The system may include a group of cleaning shot that is disposed within the quaternary annulus chamber. The system may also include a means for rotating the forward combustion can such that the group of cleaning shot tumbles within the quaternary annulus chamber.

Other embodiments, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is an example forward combustion can.

FIG. 2 is a cutaway of the forward combustion can of FIG. 1.

FIG. 3 is a flow diagram illustrating details of an example method for cleaning deposits that have accumulated in a quaternary annulus chamber, according to an embodiment of the invention

FIG. 4 is a flow diagram illustrating details of an example method for cleaning deposits that have accumulated in a quaternary annulus chamber, according to an embodiment of the invention

### DETAILED DESCRIPTION OF THE DISCLOSURE

Illustrative embodiments will now be described more fully hereinafter with reference to the accompanying drawings, in which some, but not all embodiments are shown. The present application may be embodied in many different forms and should not be construed as limited to the embodiments set forth herein. Like numbers refer to like elements throughout.

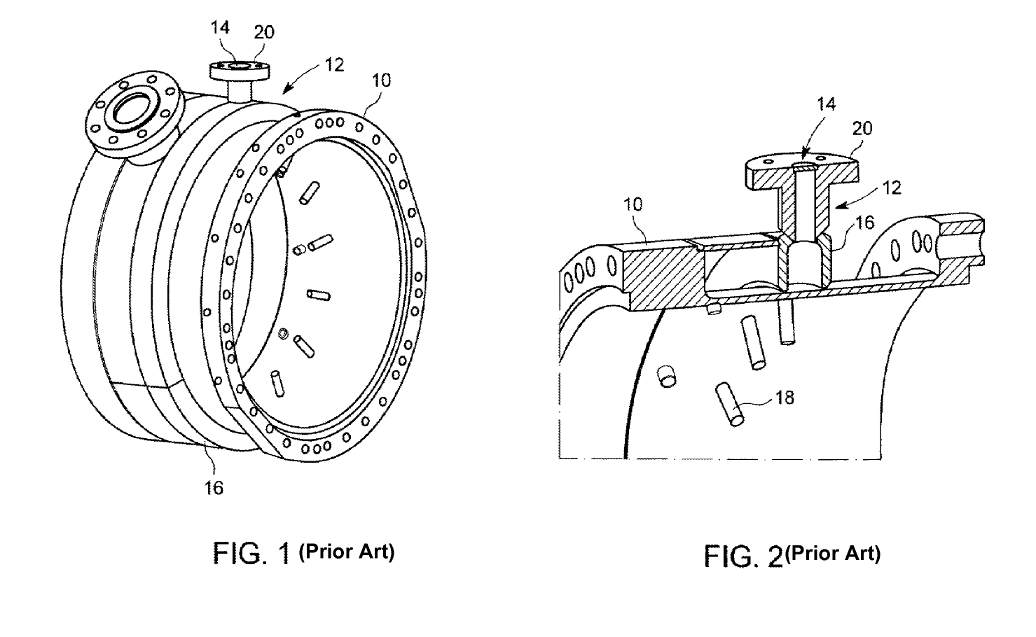

FIGS. 1 and 2 illustrate a forward combustion can 10, of the type used in gas turbines such as GE Frame 6FA, 7FA, and 9FA gas turbines. A typical gas turbine may have one or more forward combustion cans 10. The forward combustion can 10 may include a quaternary fuel circuit 12 with a quaternary fuel gas inlet orifice 14 leading to a quaternary fuel gas distribution annulus chamber 16 extending around the circumference of the forward combustion can 10. The fuel gas in the quaternary annulus chamber 16 may be distributed by multiple quaternary pegs 18 into the combustion chamber of the forward combustion can 10. The structure of the forward combustion can 10 and the quaternary annulus chamber 16 will be understood by those skilled in the art and need not be discussed in further detail herein.

It is known that undesirable deposits, such as iron oxide corrosion products, collect in the quaternary annulus chamber 16 and may result in blockage of fuel gas passages in the quaternary pegs 18. This potentially interferes with the flame pattern in the combustion chamber of the forward combustion can 10. The current disclosure is directed to a method of removing these undesirable deposits from the quaternary annulus chamber 16 of the forward combustion cans 10.

The forward combustion cans 10 may be removed from the gas turbine using conventional procedures and cleaned at a repair facility or on-site with a mobile cleaning unit using the novel systems and methods described herein such that the forward combustion cans 10 can be cleaned and placed back on the gas turbine within a short period of time rather than the weeks conventional methods required.

According to an embodiment, cleaning shot may be deposited into the quaternary annulus chamber 16. For example, the cleaning shot may be deposited into the quaternary annulus chamber 16 through the quaternary fuel inlet orifice 14. After the cleaning shot has been deposited into the quaternary annulus chamber 16, the forward combustion can 10 may be rotated such that the cleaning shot tumbles within the quaternary annulus chamber 16. For example, the forward combustion can 10 may be placed on a power roller skid and attached to a motor. As the cleaning shot tumbles within the quaternary annulus chamber 16, it removes any undesirable deposits or build-up that may have accumulated within the quaternary annulus chamber 16.

The cleaning shot may be steel pellets, BBs, or peening. One will appreciate, however, that the cleaning shot may be any shape, size, and/or material necessary to remove the undesirable deposits without damaging the forward combustion can and associated components.

In certain aspects, the direction of rotation of the forward combustion can 10 may be periodically reversed. For example, the forward combustion can 10 may be rotated a first direction, then a second direction, then a first direction again or any combination or variation thereof. In other aspects, a cleaning solution, such as denatured alcohol, may be deposited into the quaternary annulus chamber 16. After the forward combustion chamber 10 has been rotated for a cleaning cycle, the cleaning shot and the cleaning solution may be removed from the quaternary annulus chamber 16. The method may then be repeated any number of times using the cleaning shot or the cleaning solution or both. After the cleaning shot and/or cleaning solution is removed, the quaternary annulus chamber 16 may be flushed with high pressure air and/or water.

In certain embodiments, multiple forward combustion cans 10 of one or more gas turbines may be connected together. For example, multiple forward combustion cans 10 may be bolted together along respective flanges. In this embodiment, the multiple forward combustion cans 10 may be cleaned simultaneously by depositing the cleaning shot into the respective quaternary annulus chambers 16 of each forward combustion can 10 and rotating the connected forward combustion cans 10 together such that the cleaning shot tumbles within the respective quaternary annulus chamber 16. In this manner, the forward combustion cans 10 can be joined together and cleaned during a single outage. The technical and commercial advantages are substantial in terms of reduced outage time for gas turbine operators.

In certain embodiment, to prevent leakage and possible damage, the quaternary fuel pegs 18 may be capped. The quaternary fuel pegs 18 may be capped during the entire clean process or during only part of the cleaning process.

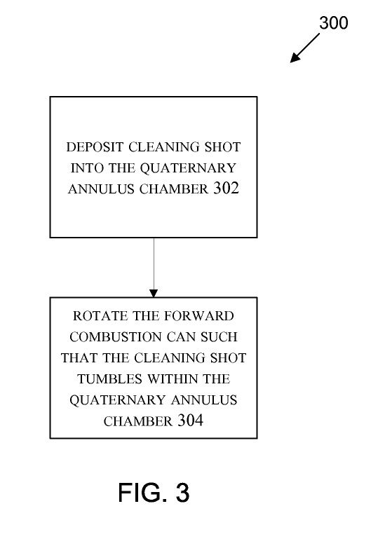

FIG. 3 illustrates an example flow diagram of a method 300 for cleaning deposits that have accumulated in the quaternary annulus chamber. In this particular embodiment, the method 300 may begin at block 302 of FIG. 3 in which the method 300 may include depositing cleaning shot into the quaternary annulus chamber. Further, at block 304, the method 300 may include rotating the forward combustion can such that the cleaning shot tumbles within the quaternary annulus chamber.

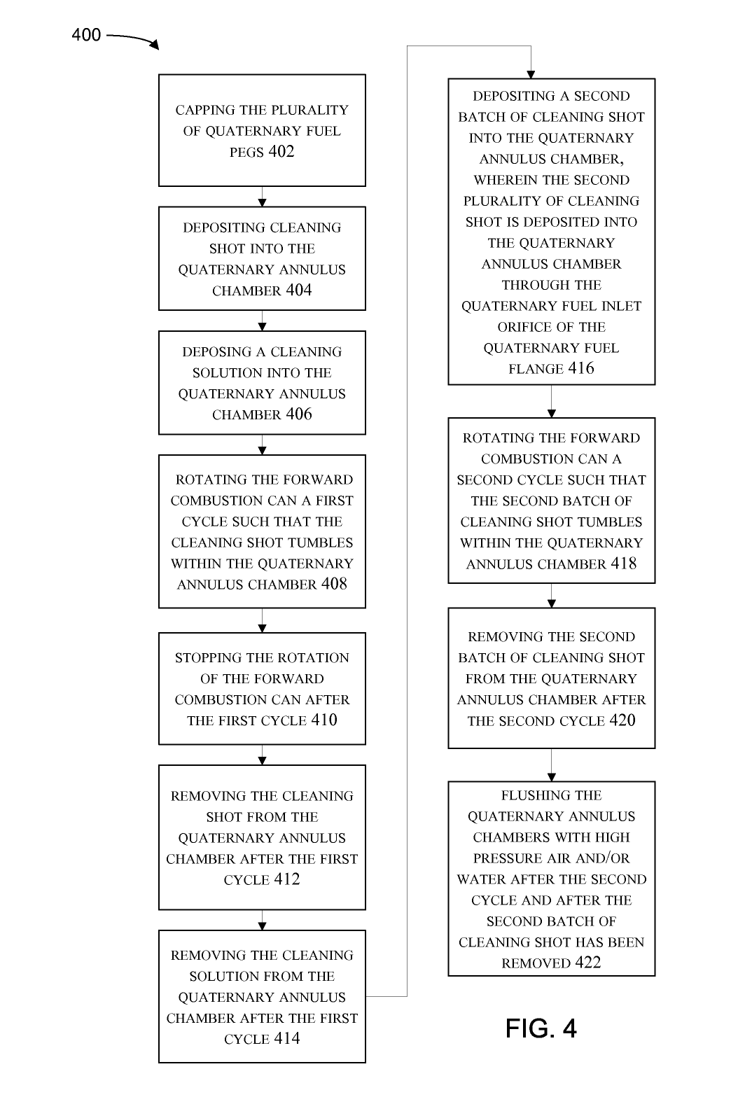

FIG. 4 illustrates another example flow diagram of a method 400 for cleaning deposits that have accumulated in the quaternary annulus chamber. In this particular embodiment, the method 400 may begin at block 402 of FIG. 4 in which the method 400 may include capping the quaternary fuel pegs. Further, at block 404, the method 400 may include depositing a first batch of cleaning shot into the quaternary annulus chamber through the quaternary fuel inlet orifice of the quaternary fuel flange. At block 406, the method 400 may include deposing a cleaning solution into the quaternary annulus chamber. As noted at block 408, the method 400 may include rotating the forward combustion can a first cycle such that the first batch of cleaning shot tumbles within the quaternary annulus chamber. At block 410, the method 400 may include stopping the rotation of the forward combustion can after the first cycle. At block 412, the method 400 may include removing the first batch of cleaning shot from the quaternary annulus chamber after the first cycle. At block 414, the method 400 may include removing the cleaning solution from the quaternary annulus chamber after the first cycle. At block 416, the method 400 may include depositing a second batch of cleaning shot into the quaternary annulus chamber through the quaternary fuel inlet orifice of the quaternary fuel flange. At block 418, the method 400 may include rotating the forward combustion can a second cycle such that the second batch of cleaning shot tumbles within the quaternary annulus chamber. At block 420, the method 400 may include removing the second batch of cleaning shot from the quaternary annulus chamber after the second cycle. At block 422, the method 400 may include flushing the quaternary annulus chambers with high pressure air and/or water after the second cycle and after the second batch of cleaning shot has been removed.

In certain aspects, the first rotation cycle may be thirty (30) minutes and include both the cleaning shot and the cleaning solution, while the second rotation cycle may be thirty (30) minutes and include only the cleaning shot. The rotation cycles, however, may be any predefined length of time. In other aspects, after the cleaning process is complete, the interior of the quaternary annulus chamber may be rinsed with a lubricant and/or cleaner, such as WD-40, and then rotated for an additional cycle to ensure that all of the cleaning shot is removed. In still other aspects, flushing the quaternary annulus chambers with high pressure air and/or water may include a reverse flow flush to ensure that all of the cleaning shot is removed from the fuel gas passages in the quaternary pegs 18. In yet another aspect, the first and second rotation cycles may be about 24 rotations per minute.

After the quaternary annulus chamber has been cleaned, the cleaning shot and/or cleaning solution may be removed from the quaternary annulus chamber, the quaternary annulus chamber may be flushed with air and/or water, and the forward combustion can may be reattached to the gas turbine.

Although the disclosure has been illustrated and described in typical embodiments, it is not intended to be limited to the details shown, because various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

That which is claimed:

1. A method for cleaning deposits that have accumulated in a quaternary annulus chamber in a forward combustion can of a gas turbine, the forward combustion can comprising a quaternary fuel flange and a quaternary fuel inlet orifice leading to the quaternary annulus chamber, the forward combustion can further comprising a plurality of quaternary fuel pegs in communication with the quaternary annulus chamber, the method comprising:
depositing a plurality of cleaning shot into the quaternary annulus chamber; and
rotating the forward combustion can such that the plurality of cleaning shot tumbles within the quaternary annulus chamber so as to dislodge the deposits therein.

2. The method of claim 1, further comprising removing the forward combustion can from the gas turbine before rotating the forward combustion can.

3. The method of claim 1, further comprising depositing a cleaning solution into the quaternary annulus chamber.

4. The method of claim 3, wherein the cleaning solution is denatured alcohol.

5. The method of claim 1, further comprising removing the plurality of cleaning shot from the quaternary annulus chamber after rotating the forward combustion can.

6. The method of claim 1, further comprising flushing the quaternary annulus chambers with high pressure air after rotating the forward combustion can and after the plurality of cleaning shot has been removed.

7. The method of claim 1, further comprising flushing the quaternary annulus chambers with water after rotating the forward combustion can and after the plurality of cleaning shot has been removed.

8. The method of claim 1, further comprising connecting multiple forward combustion cans of one or more gas turbines.

9. The method of claim 1, further comprising periodically reversing the direction of rotation of the forward combustion can.

10. The method of claim 1 further comprising capping the plurality of quaternary fuel pegs to prevent leakage.

11. The method of claim 1, wherein the plurality of cleaning shot is deposited into the quaternary annulus chamber through the quaternary fuel inlet orifice.

12. A method for cleaning deposits that have accumulated in a quaternary annulus chamber in a forward combustion can of a gas turbine, the forward combustion can comprising a quaternary fuel flange and a quaternary fuel inlet orifice leading to the quaternary annulus chamber, the forward combustion can further comprising a plurality of quaternary fuel pegs in communication with the quaternary annulus chamber, the method comprising:
removing the forward combustion can from the gas turbine;
capping the plurality of quaternary fuel pegs;
depositing a first plurality of cleaning shot into the quaternary annulus chamber, wherein the first plurality of cleaning shot is deposited into the quaternary annulus chamber through the quaternary fuel inlet orifice;
deposing a cleaning solution into the quaternary annulus chamber;
rotating the forward combustion can a first cycle such that the first plurality of cleaning shot tumbles within the quaternary annulus chamber;
stopping the rotation of the forward combustion can after the first cycle;
removing the first plurality of cleaning shot and the cleaning solution from the quaternary annulus chamber after the first cycle;
depositing a second plurality of cleaning shot into the quaternary annulus chamber, wherein the second plurality of cleaning shot is deposited into the quaternary annulus chamber through the quaternary fuel inlet orifice; and
rotating the forward combustion can a second cycle such that the second plurality of cleaning shot tumbles within the quaternary annulus chamber.

13. The method of claim 12, wherein the cleaning solution is denatured alcohol.

14. The method of claim 12, further comprising removing the second plurality of cleaning shot from the quaternary annulus chamber after the second cycle.

15. The method of claim 12, further comprising flushing the quaternary annulus chambers with high pressure air after the second cycle and after the second plurality of cleaning shot has been removed.

16. The method of claim 12, further comprising flushing the quaternary annulus chambers with water after the second cycle and after the second plurality cleaning shot has been removed.

17. The method of claim 12, further comprising connecting multiple forward combustion cans of one or more gas turbines.

18. The method of claim 12, further comprising periodically reversing the direction of rotation of the forward combustion can during the first and second cycles.

19. A system for cleaning deposits that have accumulated in a quaternary annulus chamber in a forward combustion can of a gas turbine, the forward combustion can comprising a quaternary fuel flange and a quaternary fuel inlet orifice leading to the quaternary annulus chamber, the forward combustion can further comprising a plurality of quaternary fuel pegs in communication with the quaternary annulus chamber, the system comprising:
a plurality of cleaning shot disposed within the quaternary annulus chamber;
means for rotating the forward combustion can such that the plurality of cleaning shot tumbles within the quaternary annulus chamber so as to dislodge the deposits therein.

20. The system of claim 19, further comprising a roller skid for supporting the forward combustion can during rotation.
